(19) United States
(12) Patent Application Publication
(10) Pub. No.: US 2024/0288154 A1
(43) Pub. Date: Aug. 29, 2024

(54) LED Connector Module and Electronic Device Having the Same

(71) Applicant: Tyco Electronics AMP Korea Co., Ltd., Gyeongsan (KR)

(72) Inventors: Ki Deok Cheon, Gyeongsan-Si (KR); Byung-Hee Cho, Gyeongsan-Si (KR); Sung-Chul Kim, Gyeongsan-Si (KR); Suk-Eun Jung, Gyeongsan-Si (KR)

(73) Assignee: Tyco Electronics AMP Korea Co., Ltd., Gyeongsan (KR)

(21) Appl. No.: 18/590,315

(22) Filed: Feb. 28, 2024

(30) Foreign Application Priority Data
Feb. 28, 2023 (KR) 10-2023-0026915
Jan. 15, 2024 (KR) 10-2024-0006257

(51) Int. Cl. F21V 23/06; F21W 131/305; H01R 13/11; H01R 13/50; H01R 13/627; H01R 13/631; H01R 24/20; H01R 24/76; H01R 103/00

(52) U.S. Cl. CPC F21V 23/06; H01R 13/113; H01R 13/50; H01R 13/6273; H01R 13/631; H01R 24/20; H01R 24/76; F21W 2131/305; H01R 2103/00

(57) ABSTRACT

A light-emitting diode (LED) connector module includes a header housing and a plug housing removably attached to the header housing. The header housing is installed on an LED module. The header housing has a tab terminal protruding from a coupling surface. The plug housing has a receptacle terminal and a tab terminal coupling portion. The tab terminal is inserted in the tab terminal coupling portion in contact with the receptacle terminal.

### CROSS-REFERENCE TO RELATED APPLICATION

This application claims the benefit of Korean Patent Application No. 10-2023-0026915, filed on Feb. 28, 2023, and Korean Patent Application No. 10-2024-0006257, filed on Jan. 15, 2024.

### FIELD OF THE INVENTION

The following description relates to a light-emitting diode (LED) connector module for electrically connecting an LED module of a refrigerator and the like to a mainboard and the like, and an electronic device having the LED module.

### BACKGROUND

A refrigerator is typically equipped with a lighting device that illuminates the interior of the refrigerator when the door of the refrigerator is opened. For example, the lighting device is a light-emitting diode (LED) module, and voltage is applied to the LED module by a door switch that operates based on the opening and closing of the door of the refrigerator. The door switch and the LED module are connected to a mainboard inside the inner case of the refrigerator using a wire-to-wire connector. However, when the door switch and the LED module are connected to the mainboard using the wire-to-wire connector, the complexity of a wiring harness increases and the manufacturing process is extended due to an increase in the number of unnecessary wire-to-wire connectors, resulting in a rise in overall costs.

### SUMMARY

A light-emitting diode (LED) connector module includes a header housing and a plug housing removably attached to the header housing. The header housing is installed on an LED module. The header housing has a tab terminal protruding from a coupling surface. The plug housing has a receptacle terminal and a tab terminal coupling portion. The tab terminal is inserted in the tab terminal coupling portion in contact with the receptacle terminal.

### BRIEF DESCRIPTION OF THE DRAWINGS

Features of the invention will become apparent and more readily appreciated from the following description of example embodiments, taken in conjunction with the accompanying drawings of which:

FIG. 1 is a perspective view illustrating a state in which a light-emitting diode (LED) connector module is installed on an LED module, according to an embodiment;

FIG. 2 is a perspective view illustrating a state in which a header housing is installed on an LED module in the LED connector module of FIG. 1, according to an embodiment;

FIG. 3 is a perspective view illustrating the LED connector module of FIG. 1, according to an embodiment;

FIG. 4 is an exploded perspective view illustrating the LED connector module of FIG. 3;

FIG. 5 is a perspective view illustrating a plug housing in the LED connector module of FIG. 3 from the bottom surface of the plug housing;

FIG. 6 is a perspective view illustrating a receptacle terminal according to an embodiment; and

FIG. 7 is a cross-sectional view of a plug housing illustrating an operation of assembling the receptacle terminal of FIG. 6, according to an embodiment.

### DETAILED DESCRIPTION

Hereinafter, embodiments will be described in detail with reference to the accompanying drawings. However, various alterations and modifications may be made to the embodiments. The embodiments are not meant to be limited by the descriptions of the present disclosure. The embodiments should be understood to include all changes, equivalents, and replacements within the idea and the technical scope of the disclosure.

The terminology used herein is for the purpose of describing particular embodiments only and is not to be limiting of the embodiments. The singular forms “a”, “an”, and “the” are intended to include the plural forms as well, unless the context clearly indicates otherwise. It will be further understood that the terms “comprises/comprising” and/or “includes/including” when used herein, specify the presence of stated features, integers, steps, operations, elements, components, or groups thereof, but do not preclude the presence or addition of one or more other features, integers, steps, operations, elements, components, or groups thereof.

Unless otherwise defined, all terms used herein including technical or scientific terms have the same meaning as commonly understood by one of ordinary skill in the art to which this disclosure pertains. Terms defined in dictionaries generally used should be construed as having meanings matching contextual meanings in the related art and are not to be construed as having an ideal or excessively formal meaning unless otherwise defined herein.

When describing the embodiments with reference to the accompanying drawings, like reference numerals refer to like components and a repeated description related thereto will be omitted. In the description of embodiments, detailed description of well-known related structures or functions will be omitted when it is deemed that such description will cause ambiguous interpretation of the present disclosure.

Also, in the description of the components, terms such as first, second, A, B, (a), (b) or the like may be used herein when describing components of the present disclosure. These terms are used only for the purpose of discriminating one component from another component, and the nature, the sequences, or the orders of the components are not limited by the terms. When one component is described as being “connected”, “coupled”, or “attached” to another component, it should be understood that one component may be connected or attached directly to another component, and an intervening component may also be “connected”, “coupled”, or “attached” to the components.

A component, which has the same common function as a component included in any one embodiment, will be described by using the same name in other embodiments. Unless disclosed to the contrary, the configuration disclosed in any one embodiment may be applied to other embodiments, and the specific description of the repeated configuration will be omitted.

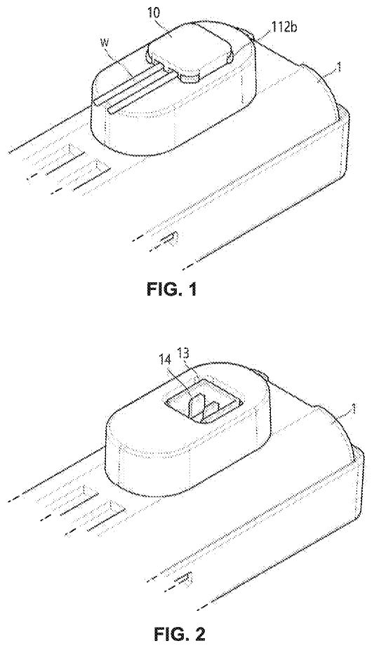

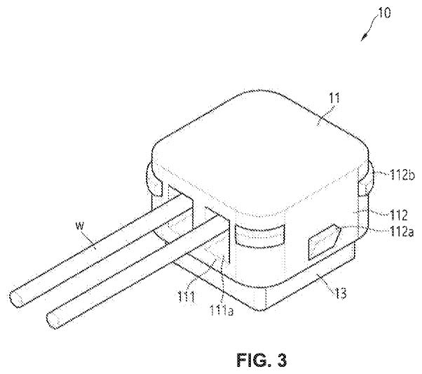

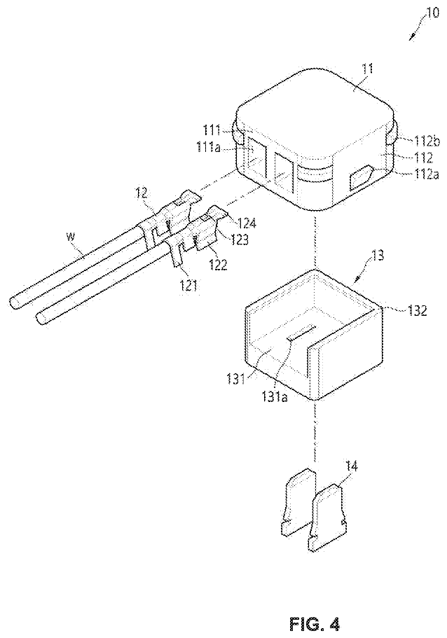

Hereinafter, a light-emitting diode (LED) connector module 10 according to an embodiment is described with reference to FIGS. 1 to 6. The LED connector module 10, as shown in FIGS. 3 and 4, may include a receptacle terminal 12, a plug housing 11, a tab terminal 14, and a header housing 13.

The LED connector module 10 may be installed on an LED module 1 including a plurality of LEDs illuminating the interior of a refrigerator, as shown in FIGS. 1 and 2. In addition, the LED connector module 10 provided on one side of the LED module 1 may be a connector assembly electrically connecting a mainboard, which is included in a space between an inner case and an outer case of the refrigerator, to the LED module 1.

The header housing 13 may be included in the LED module 1 and may include the tab terminal 14 protruding upward from a coupling surface 131 in which the header housing 13 is coupled to the plug housing 11. For example, as illustrated in FIG. 2, the header housing 13 may be embedded in the LED module 1 and formed as one. In addition, the header housing 13 may be installed in an inner portion of the refrigerator in which the LED module 1 is installed, that is, a portion toward the space between the inner case and the outer case of the refrigerator.

Referring to FIG. 4, 131a represents an installation hole 131a through which the tab terminal 14 is installed.

The header housing 13 may include a guide flange 132 that guides the coupling of the header housing 13 to the plug housing 11. The guide flange 132 may be provided on the outer side of the tab terminal 14 on the coupling surface 131 and may protrude in an upward direction, which is the direction in which the header housing 13 is coupled to the plug housing 11. For example, the guide flange 132 may be formed as a partition wall along the edge of the coupling surface 131 of the header housing 13. The guide flange 132 may extend in an upward direction on the same plane as a side surface of the header housing 13. The guide flange 132 may be formed along three edges and not a portion corresponding to a first side surface 111 in which the receptacle terminal 12 is coupled to the plug housing 11, as shown in FIG. 4. In other words, in a planar view, the shape of the guide flange 132 may be the shape of the letter “C” with straight sides.

The receptacle terminal 12 may be included in the plug housing 11 that may be removably attached to the header housing 13. In addition, the plug housing 11 may be simply attached to or detached from the header housing 13 in a plug-in manner.

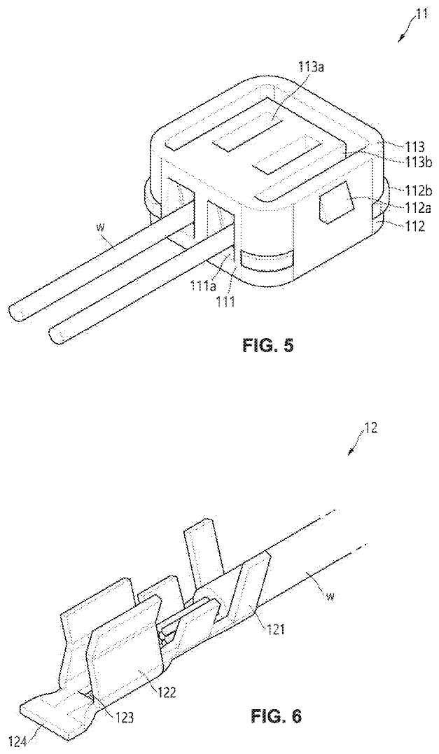

As shown in FIG. 4, a mounting portion 111a may be formed on the first side surface 111 of the outer side surfaces of the plug housing 11 such that the receptacle terminal 12 may be inserted and coupled to the plug housing 11. In addition, a tab terminal coupling portion 113a may be formed through a bottom surface 113 of the plug housing 11, as shown in FIG. 5, that is coupled to the header housing 13 such that the tab terminal 14 is inserted into the plug housing 11 to be in contact with the receptacle terminal 12.

In addition, a guide groove 113b may be formed in the bottom surface 113 of the plug housing 11, as shown in FIG. 5, and coupled to the guide flange 132. According to an embodiment, since the guide flange 132 and the guide groove 133b are provided, the plug housing 11 may guide the coupling of the plug housing 11 to the header housing 13. In addition, a state in which the plug housing 11 is coupled to the header housing 13 may be stably maintained.

A locking portion 112a may be formed on a second side surface 112 of the outer side surfaces of the plug housing 11, as shown in FIG. 5. The mounting portion 111a is not formed on the second side surface 112. The locking portion 112a may couple and fix the plug housing 11 to the LED module 1. For example, the locking portion 112a may be a protrusion protruding outward from the second side surface 112. However, this example is for ease of description. The locking portion 112a may have various shapes and sizes to couple the plug housing 11 to the LED module 1. The location of the locking portion 112a may also vary.

A stopper 112b may be formed on an outer side surface of the plug housing 11, as shown in FIG. 5. The stopper 112b may limit a moving distance in the direction in which the plug housing 11 is coupled to the header housing 13. In other words, the stopper 112b may limit the depth at which the plug housing 11 is mounted on the LED module 1. For example, the stopper 112b may be formed at a predetermined height on the outer side surface of the plug housing 11. As illustrated in FIG. 1, the stopper 112b may be caught by the LED module 1 and may limit the depth to which the plug housing 11 is inserted into the LED module 1. In addition, the stopper 112b may be formed at a corner portion along the circumference of the plug housing 11. Furthermore, a plurality of stoppers (e.g., 112b) may be formed discontinuously. Moreover, the stopper 112b may not be formed at a location in which the locking portion 112a is placed.

A wire W, shown in FIG. 6, may connect the receptacle terminal 12 to a mainboard. A barrel portion 121, to which the wire W is coupled and fixed, and a contact portion 122 and a contact slot 123, to which the tab terminal 14 is coupled, may be formed at one end of the receptacle terminal 12. While the wire W is accommodated in the barrel portion 121 and the outer circumferential surface of the wire W is wrapped by the barrel portion 121, the barrel portion 121 may be compressed and deformed. Accordingly, the barrel portion 121 may be physically coupled and fixed to the outer circumferential surface of the sheath of the wire W and may also be electrically and physically connected to a core wire of the wire W.

The contact slot 123 may be formed to be penetrated by the tab terminal 14, and the contact portion 122 may be formed to be in contact with the tab terminal 14 that passes through the contact slot 123. The receptacle terminal 12 may be attached to the plug housing 11 such that the contact slot 123 corresponds to the tab terminal coupling portion 113a. Accordingly, when the plug housing 11 is coupled to the header housing 13, the tab terminal 14 may pass through the tab terminal coupling portion 113a and the contact slot 123 simultaneously and may be in electrical contact with the contact portion 122 of the receptacle terminal 12.

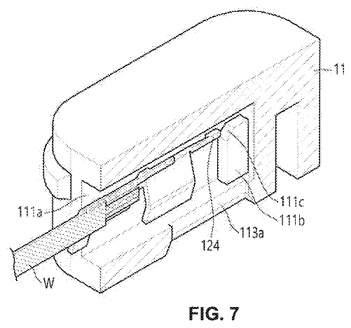

In addition, a coupling guide 124 that guides insertion may be formed at a leading end of the receptacle terminal 12 in the direction in which the receptacle terminal 12 is inserted into the plug housing 11. Referring to FIG. 7, a plug housing-side coupling guide 111b that guides the coupling of the receptacle terminal 12 to the plug housing 11 may be included in the mounting portion 111a of the plug housing 11. A portion of the upper end of the plug housing-side coupling guide 111b facing the direction in which the receptacle terminal 12 is inserted into the plug housing 11 may be an inclined surface 111c that is inclined upward. When the receptacle terminal 12 is inserted into the plug housing 11, the coupling guide 124 may move upward on the inclined surface 111c of the plug housing-side coupling guide 111b and may be placed at the right position, and accordingly, the state in which the receptacle terminal 12 is coupled to the plug housing 11 may be maintained.

According to an embodiment, because the wire W, coupled to the receptacle terminal 12, is included in the plug housing 11 and the coupling of the plug housing 11 to the header housing 13 leads to the electrical connection between the receptacle terminal 12 and the tab terminal 14, there may be no need to directly connect the wire W to the LED module 1, simplifying the structure of a wiring harness, facilitating assembly, and reducing cost. In addition, both the plug housing 11 and the header housing 13 have a sealed structure, preventing a foaming member from entering the interior of the LED connector module 10. The effects of the LED connector module 10 and an electronic device having the same according to an embodiment are not limited to the above-mentioned effects, and other unmentioned effects may be clearly understood from the description by one of ordinary skill in the art.

As described above, although the embodiments have been described with reference to the limited drawings, a person skilled in the art may apply various technical modifications and variations based thereon. For example, suitable results may be achieved if the described techniques are performed in a different order, and/or if components in a described system, architecture, device, or circuit are combined in a different manner, and/or replaced or supplemented by other components or their equivalents.

Therefore, other implementations, other embodiments, and equivalents to the claims are also within the scope of the following claims.

What is claimed is:

1. A light-emitting diode (LED) connector module, comprising:
a header housing installed on an LED module, the header housing having a tab terminal protruding from a coupling surface; and
a plug housing removably attached to the header housing, the plug housing having a receptacle terminal and a tab terminal coupling portion, the tab terminal is inserted in the tab terminal coupling portion in contact with the receptacle terminal.

2. The LED connector module of claim 1, wherein the header housing has a guide flange protruding at an outer side of the tab terminal in a direction in which the header housing is coupled to the plug housing.

3. The LED connector module of claim 2, wherein the plug housing has a guide groove into which the guide flange is inserted.

4. The LED connector module of claim 3, wherein the guide flange is formed along a circumference of the coupling surface.

5. The LED connector module of claim 4, wherein the guide flange extends on a same plane as a side surface of the header housing.

6. The LED connector module of claim 3, wherein the header housing is embedded in the LED module.

7. The LED connector module of claim 1, wherein the plug housing has a mounting portion on a side surface, the receptacle terminal is inserted in the mounting portion.

8. The LED connector module of claim 7, wherein the plug housing has a tab terminal coupling portion on a bottom surface of the plug housing, the tab terminal passes through the tab terminal coupling portion.

9. The LED connector module of claim 8, wherein the receptacle terminal has a contact slot through which the tab terminal passes.

10. The LED connector module of claim 9, wherein the receptacle terminal is attached to the plug housing with the contact slot corresponding to the tab terminal coupling portion.

11. The LED connector module of claim 9, wherein the receptacle terminal has a coupling guide at a leading end in a direction on which the receptacle terminal is inserted into the plug housing, the coupling guide guides insertion of the receptacle terminal.

12. The LED connector module of claim 11, wherein the plug housing has a housing-side coupling guide that contacts the coupling guide in the mounting portion, the housing-side coupling guide forms an inclined surface guiding the receptacle terminal to a coupling location.

13. The LED connector module of claim 1, wherein the plug housing has a stopper protruding outward from an outer side surface of the plug housing.

14. The LED connector module of claim 13, wherein the stopper limits a moving distance in a direction in which the plug housing is coupled to the header housing.

15. The LED connector module of claim 14, wherein the stopper is one of a plurality of stoppers formed discontinuously along an outer circumference of the plug housing.

16. The LED connector module of claim 14, wherein the stopper is formed at a corner portion of an outer circumference of the plug housing.

17. The LED connector module of claim 14, wherein the plug housing has a locking portion protruding outward from the outer side surface of the plug housing, the locking portion couples the plug housing with the LED module.

18. An electronic device comprising:
the LED connector module of claim 1.
